(19) United States
(12) Patent Application Publication
(10) Pub. No.: US 2024/0301136 A1
(43) Pub. Date: Sep. 12, 2024

(54) Novel Grease Thickening Agents

(71) Applicant: Thomas P Daly, Arlington Heights, IL (US)

(72) Inventor: Thomas P Daly, Arlington Heights, IL (US)

(73) Assignee: TPAT IP LLC, Arlington Heights, IL (US)

(21) Appl. No.: 18/591,684

(22) Filed: Feb. 29, 2024

Related U.S. Application Data
(60) Provisional application No. 63/449,346, filed on Mar. 2, 2023.

(51) Int. Cl. C08G 65/333; C10M 119/24; C10N 50/10

(52) U.S. Cl. CPC C08G 65/33358; C10M 119/24; C10M 2217/06; C10N 2050/10

(57) ABSTRACT

A family of ether amines that uses alkoxylates allows for the easy adjustment of rheology of greases while providing enhanced durability over the present grease thickeners.

This application is related to, and claims priority from, U.S. Provisional Patent application No. 63/449,346 filed Mar. 2, 2023. Application No. 63/449,346 is hereby incorporated by reference in its entirety.

### BACKGROUND

### Field of the Invention

The present invention relates to the field of urea and urethane thickeners based on polyalkoxy amines and alcohols.

### Description of the Problem Solved by the Invention

The manufacture of grease requires the thickening of a base oil to a viscosity that enables the grease to stay in the bearing or other mechanism that needs to be lubricated by the base oil. The present invention improves the properties of the grease through the use of novel thickeners.

### SUMMARY OF THE INVENTION

The present invention relates to the field of urea and urethane grease thickeners. The use of ureas and urethanes that increase the viscosity of the base oil results in longer lasting greases than those thickened with carboxylic acid soaps or sulfonate salts and provide better lubricity than those thickened with clays. The present invention results in the ability to make greases with a wider range of viscosities and with greater oxidative stability.

### DESCRIPTION OF THE FIGURES

Attention is now directed to the following FIGURES that describe embodiments of the present invention:

FIG. 1 shows the synthesis of novel urea, urethane and hybrid grease thickeners based in Toluene diisocyanate.

### DETAILED DESCRIPTION OF THE INVENTION

Many grease applications are now sealed systems where the grease needs to last the life of the bearing or other mechanism to be lubricated. Lithium salts of carboxylic acids have been used for many years, but as lithium costs have increased due to battery demand, these are no longer viable options. In addition, the lithium and calcium salts of carboxylic acids and sulfonates lack the oxidative stability of ureas.

The present invention is the use of ether amines as thickening agents. The preferred starting materials are from the Proxamine® family of ether amines produced by Crison Chemistry, but more traditional ether amines by Evonik®, trade named Tomamines®, that are produced by reacting acrylonitrile with EXXAL® alcohols and reduced to the primary amine functionality may be used. Additionally, linear alcohols from the dehydration of fatty acids are also suitable starting materials to make the ether amines.

The preferred isocyanate is toluene diisocyanate and its isomers. Toluene diisocyanate is preferred for its electron density and its commercial availability. However, any polyisocyanate is acceptable, such as p-phenylene diisocyanate, naphthalene diisocyanate, diphenylmethane diisocyanate, hexamethylene diisocyanate, Isophrone diisocyanate, methylene diphenyl diisocyanate as well as any other polyisocyanate that results in satisfactory thickening.

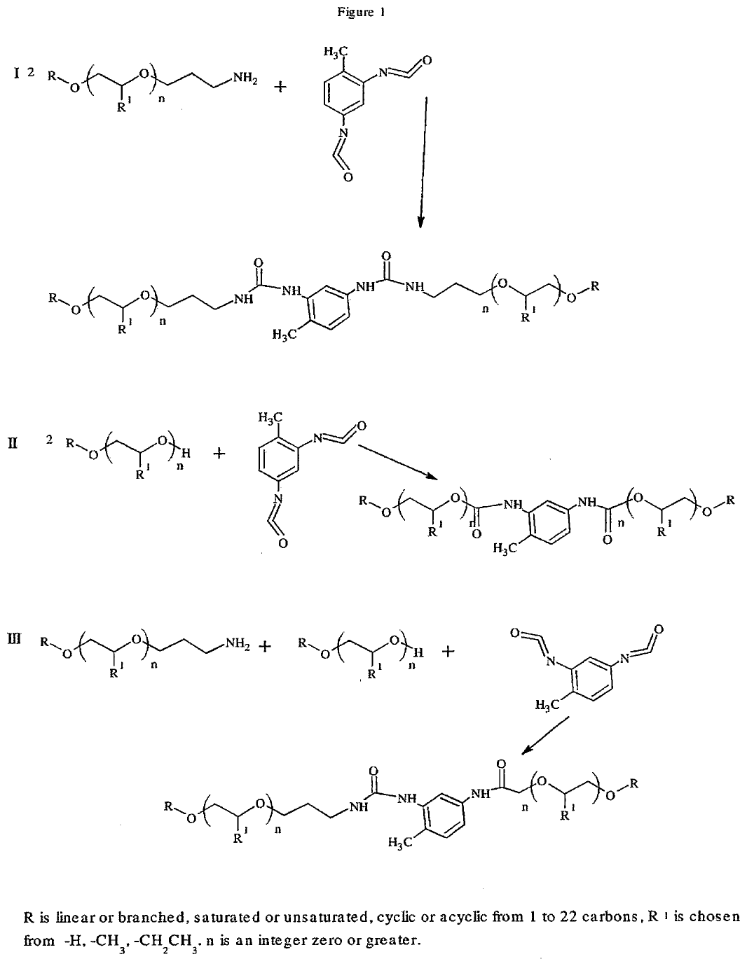

FIG. 1, line I, shows the synthesis of a general Proxamine® based ether amine used to make a urea thickener with toluene diisocyanate. FIG. 1, line II, shows the synthesis of the urethane based thickeners. These are less effective and shorter lifespans, but are still more desireable than carboxylic acid soaps as thickeners. FIG. 1, line III, shows the hybrid urea/urethane thickeners.

### Example 1

To 400 g of Hydrocal 500™ (obtained from Calumet Specialty Products) was added 493 g of Proxamine® nB51 (obtained from Crison Chemistry). To this mixture added 104 g of toluene diisocyanate was added over 10 minutes and the mixture increased in viscosity substantially and exothermed to 75 C. The temperature was raised slowly to 165 C and held for 4 hours. After cooling to ambient temperature, the result was a base grease of high viscosity and smooth consistency.

I claim:

1. The grease thickener of the following structure: 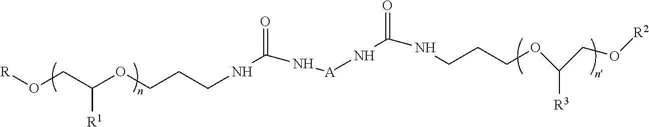
R and R² are linear or branched, saturated or unsaturated, cyclic or acyclic from 1 to 22 carbons, R¹ and R³ are chosen from —H, —CH₃, —CH₂CH₃, n and n′ are integers zero or greater; A is linear or branched, saturated or unsaturated, cyclic or acyclic from 1 to 8.

2. The grease thickener of claim 1 where A is toluene.

3. The grease thickener of claim 1 where A is —C₆H₁₂—.

4. The grease thickener of claim 1 where A is —C₆H₁₂-CH₃—C₆H₁₂—.

5. The grease thickener of the following structure: 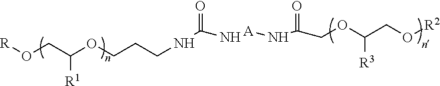
Where R and R² are linear or branched, saturated or unsaturated, cyclic or acyclic from 1 to 22 carbons, R¹ and R³ are chosen from —H, —CH₃, —CH₂CH₃, n and n′ are integers zero or greater; A is linear or branched, saturated or unsaturated, cyclic or acyclic from 1 to 8.

6. The grease thickener of claim 5 where A is toluene.

7. The grease thickener of claim 5 where A is —C₆H₁₂—.

8. The grease thickener of claim 5 where A is —C₆H₁₂-CH₃—C₆H₁₂—.

9. The grease thickener of the following structure: 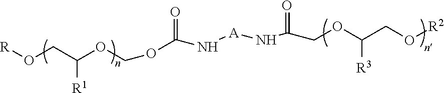
Where R and R² are linear or branched, saturated or unsaturated, cyclic or acyclic from 1 to 22 carbons, R¹ and R³ are chosen from —H, —CH₃, —CH₂CH₃, n and n′ are integers zero or greater, A is linear or branched, saturated or unsaturated, cyclic or acyclic from 1 to 8.

10. The grease thickener of claim 9 where A is toluene.

11. The grease thickener of claim 9 where A is —C₆H₁₂—.

12. The grease thickener of claim 9 where A is —C₆H₁₂-CH₃—C₆H₁₂—.
